(19) United States
(12) Patent Application Publication
(10) Pub. No.: US 2015/0335183 A1
(43) Pub. Date: Nov. 26, 2015

(54) Smart Container

(71) Applicants: Suhasini Balachandran, Wildwood, MO (US); Andrea Theresa Jersa, Wildwood, MO (US)

(72) Inventors: Suhasini Balachandran, Wildwood, MO (US); Andrea Theresa Jersa, Wildwood, MO (US)

(21) Appl. No.: 14/287,110

(22) Filed: May 26, 2014

(51) Int. Cl. A47G 19/22; G09F 3/02

(52) U.S. Cl. CPC A47G 19/2288; G09F 3/02

(57) ABSTRACT

A method and apparatus for receiving an electronic signal in a smart container and notifying a user of the electronic signal comprises coupling an electronic receiver to the smart container and coupling a display panel to the electronic receiver are disclosed. Receiving the electronic signal by the electronic receiver from an electronic device transmitter, and digitally displaying the electronic signal on the display panel of the smart container to notify the user of the electronic signal are also disclosed.

### FIELD OF THE INVENTION

This invention relates to a smart container, and more particularly to a method and apparatus for connecting a container to an electronic device.

### BACKGROUND OF THE INVENTION

Most consumers employ containers as a means for consumption of beverages. A traditional container includes a base portion that is formed with a cylinderical sidewall. A handle is provided on the cylindrical sidewall for grasping by a user. Consequently, apart from consuming a beverage, the user may not be able to utilize the container for performing any other function. Moreover, during circumstances in which it is required to heat the beverage in the container, the user may be required to employ the services of an external heating device. Consequently, the user may not be able to exploit a utility value of the container in the best possible manner. Therefore, there exists a need for a container with a display panel that would enable the user to interactively use the container for performing a number of electronic functions, as well as for heating fluid content in the container.

The need has existed for many years, yet there is no fully satisfactory system to meet the need. In accordance with a long recognized need, there has been developed a smart container to satisfy many users' communication and fluid heating requirements. The smart container itself is compact and easily interchangeable with electronic devices of various types such as cell phones, smart containers, remote control devices, computer systems, Etc. It is a versatile device which can be used to receive/transmit electronic signals from/to an electronic device, as well as perform the function of heating the fluid content therein. Importantly, the smart container is efficient in operation.

### BRIEF DESCRIPTION OF THE INVENTION

In one aspect, a method is provided for receiving an electronic signal in a smart container and notifying a user of the electronic signal. The method comprises coupling an electronic receiver to the smart container, and coupling a display panel to the electronic receiver. The method also includes receiving the electronic signal by the electronic receiver from an electronic device transmitter, and digitally displaying the electronic signal on the display panel of the smart container to notify the user of the electronic signal.

In another aspect of the invention, a smart container is provided. The smart container comprises a base portion and a sidewall integrally formed with and extending upwardly from the base portion. The sidewall surrounds an inner cavity, and has an upper edge that defines an opening into the inner cavity. An electronic receiver is coupled to one of the base portion and the sidewall and is configured to receive an electronic signal. A display panel is coupled to the electronic receiver and is configured to digitally display the electronic signal.

In a further aspect, a smart container is provided. The smart container comprises a base portion and a sidewall integrally formed with and extending upwardly from the base portion. The sidewall surrounds an inner cavity, and has an upper edge that defines an opening into the inner cavity. An electrical resistance coil/flame burner is coupled to one of an outer sidewall, an outer base portion, and a handle of the smart container.

### BRIEF DESCRIPTION OF THE DRAWINGS

FIG. 1 is a schematic representation of a smart container in electronic communication with an electronic device.

FIG. 2 is a block diagram of a communication system that exists between the electronic device and the smart container shown in FIG. 1.

FIG. 3 is a flow diagram showing an exemplary control method between the electronic device and the smart container shown in FIG. 1.

FIG. 4 is a flow diagram showing an exemplary control method between the electronic device and the smart container shown in FIG. 1.

### DETAILED DESCRIPTION OF THE INVENTION

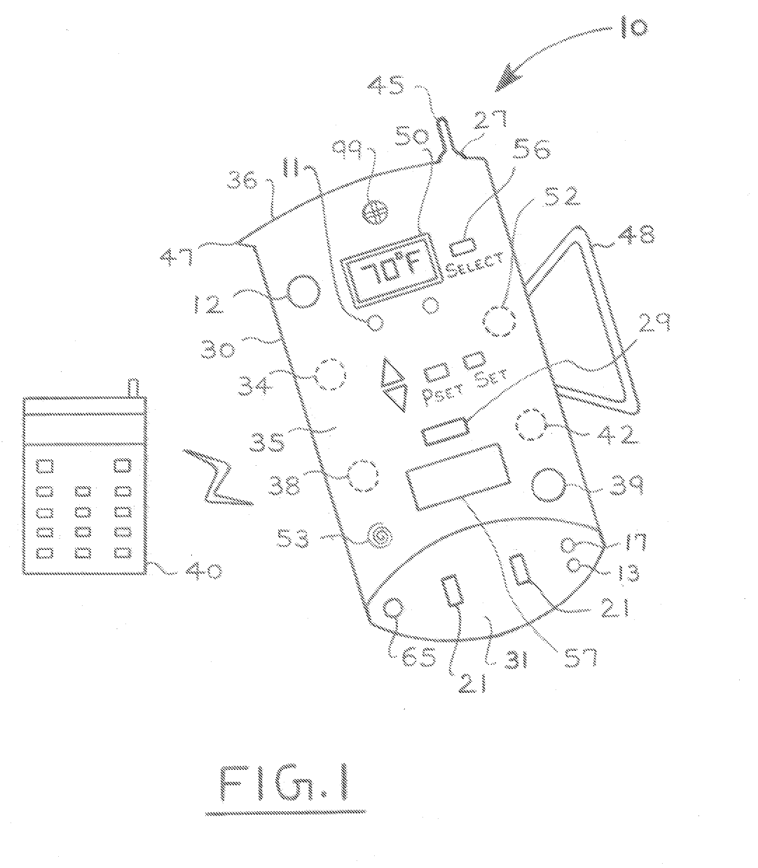

FIG. 1 is a schematic representation of a smart container and electronic device 10. More specifically, in the exemplary embodiment, a smart container 30 is in electronic communication with an electronic device 40. The smart container 30 comprises a base portion and a sidewall 35 integrally formed with and extending upwardly from the base portion. The sidewall 35 surrounds an inner cavity and has an upper edge 36 defining an opening into the inner cavity. The smart container 30 may be any container known in the art that is capable of retaining a fluid therein. The smart container 30 includes but is not limited to a bottle, a jar, a can, a box, a drum, a receptacle, a cup, a mug, a tumbler, a bowl, a vase, a jug, a pot, a vessel, a flask, a bucket, a cap, and a holder.

The electronic device 40 may be a cell phone, a remote control wireless device, a smart container, or any other wireless electronic communication device known in the art that is capable of transmitting an electronic signal to the smart container 30. The electronic device 40 includes an electronic receiver (not shown) that is configured to receive electronic communication including an electronic text message from a sender or a telephone call from a caller. On receiving electronic communication, electronic device 40 is configured to transmit an electronic signal to the smart container 30. More specifically, electronic device 40 is configured to transmit the electronic signal to the smart container 30 through an electronic transmitter (not shown) coupled to the electronic device 40. In an exemplary embodiment, the electronic signal includes an electronic text message with identifying information including a telephone number and/or an associated name of a sender, or identifying information including a telephone number and/or an associated name of a caller. In addition, the electronic signal may be any type of electromagnetic signal that facilitates operation of the smart container and electronic device 10 as described herein.

In the exemplary embodiment, smart container 30 includes an electronic receiver 34 coupled to the smart container 30. Electronic receiver 34 is configured to be electronically coupled to the electronic transmitter that is coupled to the electronic device 40 and is configured to receive the electronic signal transmitted from the electronic transmitter. In an exemplary embodiment, electronic receiver 34 may be a wireless radio receiver, a wireless Bluetooth® receiver, a wireless CDMA receiver, Etc. depending on a signal range required by the user for receiving the electronic signal from the electronic transmitter coupled to the electronic device 40. Alternatively, electronic receiver 34 may be any type of wireless electronic receiver known in the art that may be configured to receive an electromagnetic signal from the electronic transmitter coupled to the electronic device 40.

In an exemplary embodiment, smart container 30 includes a vibrating unit 38 that is electronically coupled to the electronic receiver 34 and is configured to vibrate when the electronic signal is received from the electronic device 40. More specifically, electronic receiver 34 is configured to facilitate actuating the vibrating unit 38 when the electronic signal is received from the electronic transmitter coupled to the electronic device 40. As a consequence of the vibrations sensed by the user, the user is cognizant of the electronic signal received by the electronic receiver 34 of the smart container 30 and consequently of the electronic communication received by the electronic device 40. Alternatively, an audible alarm 99 may be coupled to the electronic receiver 34 and emits an alarm that enables the user to be cognizant of the electronic signal received by the electronic receiver 34 of the smart container 30. The audible alarm 99 may emit an alarm to alert the user of a location of the smart container 30 in the event that the smart container 30 has been misplaced within a certain location such as within a residential home when the electronic device 40 is operated by the user. In an alternate exemplary embodiment, the audible alarm 99 may be substituted with an LED 39 that emits light and enables the user to be cognizant of the electronic signal received by the electronic receiver 34 of the smart container 30. In addition, in the exemplary embodiment, a display panel 50 is electronically coupled to the electronic receiver 34. The display panel 50 is configured to digitally display the electronic signal that includes the electronic text message with identifying information including the telephone number and/or the associated name of the sender, or identifying information including the telephone number and/or the associated name of the caller.

Smart container 30 includes a memory unit 52 coupled to the smart container 30. Memory unit 52 is electronically coupled to the electronic receiver 34 and is configured to acquire and store the electronic signal from the electronic receiver 34. More specifically, memory unit 52 is configured to acquire and store a finite list of entries that includes a finite number of electronic text messages with identifying information including the telephone numbers and/or the associated names of the senders, and a finite number of telephone numbers and/or the associated names of the callers. Memory unit 52 is further configured to automatically delete the oldest of the stored electronic text messages and telephone numbers in chronological order as the latest electronic text messages and telephone numbers are continuously acquired and stored by the memory unit 52 from the electronic receiver 34. The memory unit 52 is also adapted to store games, customizable time displays, alarm clock, calendar, calculator Etc. which may be displayed on the display panel 50 when required by the user. In an alternate exemplary embodiment, the memory unit 52 may be substituted by any memory device such as but not limited to a computer chip, an integrated circuit, a memory card, a memory stick, and a magnetic medium. In an exemplary embodiment, the smart container 30 may be provided with a slot (not shown) on the outer sidewall 35 of the smart container 30 for receiving the memory device therein.

In the exemplary embodiment, smart container 30 includes a selector option switch 56. Selector option switch 56 may be operated by the user to select a recipient telephone number/associated recipient name from the list of telephone numbers acquired and stored by the memory unit 52 where an electronic text message is required to be delivered. More specifically, the user may select the recipient telephone number/associated recipient name from the list of entries acquired and stored by the memory unit 52 by operating the selector option switch 56. Thereafter, the user may electronically scroll and select an electronic text message from a plurality of pre-programmed electronic text messages stored in the memory unit 52 of the smart container 30. In addition, after the electronic text message has been selected, the user may confirm the selected electronic text message by operating a confirming option switch (not shown). Alternatively, the selector option switch 56 and confirming option switch may be substituted with a touch screen selector and a touch screen confirming option respectively.

The smart container 30 includes a feature wherein an electronic text message may be typed using a touch screen key pad provided on the outer sidewall 35 of the smart container 30. In an alternate exemplary embodiment, the smart container 30 includes a feature wherein the user can speak an electronic text message into a microphone (not shown) provided on the outer sidewall 35 of the smart container 30. The message that may be spoken into the microphone may be deciphered within the smart container 30 and displayed on the display panel 50.

Smart container 30 includes an electronic transmitter 42 that is electronically coupled to the memory unit 52 of the smart container 30. Electronic transmitter 42 is configured to be electronically coupled to an electronic receiver coupled to the electronic device 40 and is configured to transmit the selected electronic text message/the typed electronic text message/the spoken electronic text message as well as the recipient telephone number/associated recipient name in the form of an electromagnetic signal to the electronic receiver. In an alternate embodiment, the spoken electronic text message may be transmitted to the electronic device 40 using the electronic transmitter 42 where it may then be deciphered by the electronic device 40. In an exemplary embodiment, electronic transmitter 42 may be a wireless radio transmitter, a wireless CDMA transmitter, or a wireless Bluetooth® transmitter depending on a signal range required by the user for transmitting the selected electronic text message/the typed electronic text message/the spoken electronic text message as well as the recipient telephone number/associated recipient name to the electronic device 40. Alternatively, electronic transmitter 42 may be any type of wireless electronic transmitter known in the art that may be configured to transmit an electronic signal to the electronic receiver coupled to the electronic device 40. In an exemplary embodiment, the electronic receiver 34 and electronic transmitter 42 may be replaced by an integrated electronic receiver/transmitter that is capable of receiving/transmitting electronic signals from/to the electronic device 40.

Electronic device 40 is further configured to automatically transmit the selected electronic text message/the typed electronic text message/the spoken electronic text message to the recipient's telephone through an electronic transmitter coupled within the electronic device 40. A copy of the transmitted electronic text message with an optional recipient's name/recipient's telephone number is saved within a memory unit that is coupled to the electronic device 40. In an exemplary embodiment, a single electronic receiver coupled to the electronic device 40 may be used to receive electronic signals from a variety of external electronic signal transmitting sources as well as the electronic transmitter 42. In addition, in an exemplary embodiment, a single electronic transmitter coupled to the electronic device 40 may be used to transmit electronic signals to the electronic receiver 34 as well as to the telephone of the recipient.

Smart container 30 is further configured to receive an electronic signal in real-time by the electronic receiver 34 from the electronic transmitter that is coupled to the electronic device 40. In an exemplary embodiment, the electronic signal received by the electronic receiver 34 in real-time comprises a current date and time. The electronic signal comprising the current date and time may be digitally displayed on the display panel 50 of the smart container 30. Moreover, smart container 30 may be further configured to receive a variety of continuous/intermittent electronic signals by the electronic receiver 34 from the electronic transmitter coupled to the electronic device 40. The continuous/intermittent electronic signals received by the electronic receiver 34 comprises a variety of electronic signals such as but not limited to a calendar appointment notification signal, an e-mail notification signal, a current local weather signal, a current altitude signal, a current local temperature signal, a current local pressure signal, a current stock ticker signal, a ring tone signal, a current sport score signal, a current news flash signal, a video conferencing signal, an advertisement signal, a photographic image signal, a motion video signal, an audio signal, a social media notification signal, and a current GPS navigation signal.

In an exemplary embodiment, each of the continuous/intermittent electronic signals may be selectively digitally displayed on the display panel 50 of the smart container 30 to be observed by the user. More specifically, in an exemplary embodiment, a variety of continuous/intermittent electronic signals may be received from a variety of external, transmitting sources to the electronic receiver coupled to the electronic device 40. In an exemplary embodiment, electronic receiver 34 may be configured to receive any electronic signal from the electronic device 40 that is received from the variety of external transmitting sources to the electronic receiver coupled to the electronic device 40. In a further exemplary embodiment, electronic receiver 34 may be programmable to receive a desired selection of electronic signals from the electronic device 40. More specifically, electronic receiver 34 may be programmable to receive a desired selection of electronic signals using software applications from a variety of electronic devices including a cell phone, a remote control device, a personal computer, a smart container, or any other electronic device known in the art.

In an exemplary embodiment, smart container 30 includes a transparent storage chamber for receiving fluid within the cavity of the smart container 30. The transparent storage chamber may have graduated markings from the upper edge 36 of the smart container 30 to the base portion of the smart container 30 to indicate a volume of fluid present within the cavity of the smart container 30.

Smart container 30 includes an electrically powered heating element (not shown) coupled to or proximate to an inner base portion of the smart container 30. Thus, as the heating element of the smart container 30 is powered by electricity, the heating element generates heat. The heat generated by the heating element naturally rises and warms the fluid content in the smart container 30. A temperature of the heating element immersed in the fluid will require a short time to begin rising after the heating element is powered by electricity. This is due to thermal inertia of the heating element. The heating element temperature will then increase at a substantially constant rate until a boiling point of the fluid is attained during which time a rate of heat transfer between the heating element and fluid will be slow. This is because the fluid temperature needs to catch up with the heating element temperature, and will finally attain a state of thermal equilibrium as the heating element temperature stabilizes. When the heating element is switched on with no fluid in the smart container 30, there is a much more rapid rate of temperature rise in the heating element, as might be expected, as there is no levelling off of the rate of temperature rise as a boiling point temperature of the fluid is approached. In an alternate exemplary embodiment, an infrared heater (not shown) may be coupled to an inner sidewall and/or the inner base portion of the smart container 30 to heat the fluid content in the smart container 30. The heating element may be substituted by any other heating source known in the art to facilitate heating the fluid content in the smart container 30.

The heating element may be controlled by the user for a range of operations from simmering to quick heating the fluid within the cavity of the smart container 30. More specifically, the smart container 30 may be provided with ascending power levels 1-5. By selecting the power level 1, the fluid in the smart container 30 may be gradually heated to its boiling point by supplying the heating element with low power. By selecting the power level 5, the fluid in the smart container 30 may be heated rapidly to its boiling point by supplying the heating element with high power.

In an exemplary embodiment, smart container 30 includes a proximity sensor 65 coupled to an outer base portion 31 of the smart container 30. More specifically, the proximity sensor 65 may be coupled within coupled to the heating element. Proximity sensor 65 determines if the smart container 30 is placed on a substantially flat surface. More specifically, proximity sensor 65 a recessed portion defined in the outer base portion 31 of the smart container 30 and may be facilitates automatically powering the heating element when the smart container 30 is placed on a substantially flat surface such as on a desk. Proximity sensor 65 facilitates automatically turning off the power supply to the heating element when the smart container 30 is lifted from the substantially flat surface by the user. In an alternate exemplary embodiment, proximity sensor 65 facilitates automatically turning off the power supply to the heating element when the smart container 30 is placed on the substantially flat surface. Proximity sensor 65 facilitates automatically powering the heating element when the smart container 30 is lifted from the substantially flat surface by the user. This function that is performed by the proximity sensor 65 facilitates the user from using the smart container 30 efficiently by heating the fluid only when the user desires to pick up and consume the fluid in the cavity of the smart container 30.

In an exemplary embodiment, smart container 30 may be configured to minimize heat losses due to conduction, convection, and radiation effects. More specifically, smart container 30 may be formed from a double walled construction. The spacing between the two walls of the double walled construction of the smart container 30 includes a vacuum-gap to minimize heat losses due to convection. Moreover, the smart container 30 may be constructed from a synthetic resin, plastic material, ceramic material, composite material, fibreglass material, wood, or any other suitable insulating material known in the art that would minimize heat losses from the smart container 30 due to conduction. In addition, the outer sidewall 35 of the smart container 30 may be circumferentially surrounded by a band manufactured from an insulated material to minimize heat losses due to conduction. Moreover, minimizing heat loss from the fluid in the smart container 30 facilitates maintaining substantially constant temperature of various electronic components that are coupled to/integrally formed in the smart container 30. In an exemplary embodiment, the smart container 30 may have silvered internal surfaces on all sides excluding a narrow display panel portion of transparency that extends from the upper edge 36 of the smart container 30 to the base portion of the smart container 30 to minimize heat losses due to radiation. The narrow display panel portion of transparency may be provided for the user to continuously monitor a level of fluid in the cavity of the smart container 30.

In an exemplary embodiment, smart container 30 may be shatter resistant. More specifically, the smart container 30 may be manufactured from any material known in the art that prevents the smart container 30 from shattering if it is dropped from a height and impacts on a hard surface.

The smart container 30 includes a control unit 12 that may be coupled to the smart container 30. The control unit 12 is coupled to a temperature transducer (not shown) such as a thermocouple positioned proximate to the inner base portion of the smart container 30 through a control flow path. More specifically, the control unit 12 may be configured to receive an electronic signal from the temperature transducer that may be indicative of a temperature of fluid in the cavity of the smart container 30. The control unit 12 may be coupled to the display panel 50. The control unit 12 facilitates digitally displaying the temperature of fluid in the cavity of the smart container 30 in the display panel 50 to notify the user of the temperature of fluid in the cavity of the smart container 30.

The control unit 12 may be coupled to an electrical circuit that is connected to the heating element. More specifically, the control unit 12 may be programmable by the user using the PSET switch, upper/lower arrow switches, and SET switch that may be provided on the outer sidewall 35 of the smart container 30 to set an upper temperature limit and a lower temperature limit of the heating element. Therefore, the upper temperature limit and the lower temperature limit of the heating element defines the upper and lower temperature limits of the fluid content in the smart container 30. The heating element may be automatically controlled by the control unit 12 to turn on when the fluid content in the smart container 30 attains the lower temperature limit and turn off when the fluid content in the smart container 30 attains the upper temperature limit. In an exemplary embodiment, if the fluid in the smart container 30 is not consumed, the temperature of fluid in the smart container 30 gradually decreases. When the temperature of fluid in the smart container 30 attains the lower temperature limit, the control unit 12 activates the heating element to automatically turn on, thereby heating the fluid in the smart container 30. If the fluid is not consumed by the user a second time, the control unit 12 does not control the heating element thereby allowing the temperature of fluid to decrease below the lower temperature limit until it attains thermal equilibrium. Therefore the control unit 12 facilitates controlling the heating element to turn on only once automatically during a heating cycle. An electronic signal may be displayed on the display panel 50 that the heating element will not be activated until initiated by the user.

The smart container 30 may be remotely programmed by the electronic device 40. In an exemplary embodiment, the wireless receiver 34 may be coupled to the control unit 12. More specifically, the electronic device 40 facilitates programming the upper temperature limit, the lower temperature limit, and activating the heating element of the smart container 30 from a remote location by transmitting an electronic signal to the electronic receiver 34. The audible alarm 99 may be coupled to the control unit 12. The audible alarm 99 may be activated to emit an alarm by transmitting an electronic signal from the electronic device 40 remotely to the electronic receiver 34 when the smart container 30 has been misplaced.

In an exemplary embodiment, an LED 11 may be coupled to the smart container 30. LED 11 may be coupled to the control unit 12 through a control flow path (not shown). More specifically, the LED 11 may be configured to turn on when the heating element is powered by electricity and the fluid content in the smart container 30 is heating up. The LED 11 may be configured to turn off/display another color when the fluid content in the smart container 30 attains the upper temperature limit that is programmed in the control unit 12 by the user. In an alternate exemplary embodiment, the audible alarm 99 emits an alarm that enables the user to be cognizant of the upper temperature limit that has been attained by the fluid content in the cavity of the smart container 30.

In an exemplary embodiment, smart container 30 may be provided with a stirrer (not shown) that may be coupled within the cavity of the smart container 30. The stirrer may be a mechanical/magnetic stirrer that may be activated by a switch (not shown). More specifically, the stirrer may be activated by the switch to facilitate stirring the fluid content in the smart container 30. The agitation caused by the stirrer causes the fluid content in the smart container 30 to mix, thereby allowing the fluid to attain a homogenous constitution as well as maintain uniform temperature. In an alternate exemplary embodiment, the stirrer may be substituted with any type of agitator device known in the art that facilitates the fluid in the smart container 30 from attaining a homogenous constitution while maintaining uniform temperature. In an exemplary embodiment, the stirrer may be coupled to the control unit 12 through a control flow path.

In an exemplary embodiment, a thermometer 27 may be coupled to the smart container 30. More specifically, a sensor 45 of the thermometer 27 may be provided as a projection on the upper edge 36 of the smart container 30 and may be configured to measure the user's body temperature. The user may position the sensor 45 of the thermometer 27 within his mouth for a pre-determined time interval, allowing the sensor 45 to sense his body temperature. The control unit 12 may be coupled to the sensor 45 of the thermometer 27 through a control flow path (not shown). An electronic signal from the sensor 45 of the thermometer 27 may be transmitted to the control unit 12 that may be indicative of the user's body temperature. The control unit 12 facilitates digitally displaying the user's body temperature in the display panel 50 to notify the user of the user's body temperature. In an alternate exemplary embodiment, the thermometer 27 may be positioned anywhere on the outer sidewall 35 of the smart container 30 and may be configured to determine the user's body temperature from a user's body portion that is in contact with the sensor 45 of the thermometer 27. In a still further alternate embodiment, the thermometer 27 may be substituted by a thermometer that may be configured to determine an ambient air temperature.

In an exemplary embodiment, an alcohol sensor (not shown) may be coupled to the smart container 30. More specifically, the alcohol sensor may be configured to measure a concentration of alcohol consumed by the user. More specifically, the user may position the alcohol sensor within proximity of his mouth for a pre-determined time interval, allowing the alcohol sensor to sense the content of alcohol in a user's breath. The control unit 12 may be coupled to the alcohol monitoring sensor through a control flow path. An electronic signal from the alcohol monitoring sensor may be transmitted to the control unit 12 that may be indicative of the content of alcohol in the user's breath. The control unit 12 facilitates digitally displaying the content of alcohol in the user's breath in the display panel 50 to notify the user. The control unit 12 facilitates digitally displaying a safe/legal permissible content of alcohol in the display panel 50 to notify the user of the acceptable content of alcohol for safe driving. If the content of alcohol in the user's breath is greater than the acceptable content of alcohol for safe driving/legal limit, the control unit 12 transmits an electronic signal to the audible alarm 99 to notify the user that the content of alcohol in the user's breath is greater than the acceptable content of alcohol for safe driving/legal limit.

The smart container 30 includes a lip 47 that may be provided on the upper edge 36 of the smart container 30. More specifically the lip 47 facilitates easy transfer of the fluid from the cavity of the smart container 30 into the mouth of the user when the fluid is being consumed. In an embodiment, the lip 47 may be but is not limited to a triangular shaped projection, a lip shaped depression, or flat surface defined on the upper edge 36 of the smart container 30.

Control unit 12 may be further configured to be coupled to a fluid level indicator transducer (not shown) through a control flow path. Control unit 12 may be configured to determine a level of fluid in the smart container 30. Control unit 12 transmits an electronic signal to the audible alarm 99 when a level of fluid in the smart container 30 decreases below a threshold fluid level. Control unit 12 may be configured to break the electrical circuit of the heating element thereby eliminating the supply of electricity to the heating element when the level of fluid in the smart container 30 decreases below the threshold fluid level. The fluid level indicator transducer may be any type of commercially available transducer that operates on the principle described above. The threshold fluid level may be manually/remotely programmable at a control unit terminal of the control unit 12 by the user.

In an exemplary embodiment, the smart container 30 may be provided with an electrical resistance coil 53. Electrical resistance coil 53 may be coupled within a recess defined in the outer base portion 31 of the smart container 30. In an alternate exemplary embodiment, the electrical resistance coil 53 may be coupled to any portion of the outer sidewall 35 of the smart container 30 using any fastening means known in the art. More specifically, the electrical resistance coil 53 may be coupled to a switch (not shown) that may be activated by the user to power the electrical resistance coil 53. In an alternate exemplary embodiment, the electrical resistance coil 53 may be coupled to the control unit 12 via a control flow path (not shown) and may be activated by the user to power the electrical resistance coil 53. The electrical resistance coil 53 may therefore be operated to function as a cigarette lighter by the user. In an alternate exemplary embodiment, the electrical resistance coil 53 may be substituted by a flame burner (not shown) that may be coupled to a fuel storage tank. The fuel storage tank may be used to supply fuel to the flame burner, which when ignited generates a flame, when the switch is activated by the user. In an alternate exemplary embodiment, the electrical resistance coil 53/flame burner that is coupled to the fuel storage tank may be substituted by coupling any device known in the art to the outer sidewall 35 of the smart container 30 that facilitates lighting a cigarette or any other flammable material. A spring actuated/mechanically actuated/sliding mechanism flap (not shown) may be provided on the outer sidewall 35 of the smart container 30 to cover the electrical resistance coil 53. More specifically, the flap may be actuated to open/close, thereby allowing the user to gain access to the electrical resistance coil 53 only when it is required. In an embodiment, the electrical resistance coil 53 may be configured to be activated only when the flap is actuated to open. The flap that may be provided on the outer sidewall 35 of the smart container 30 facilitates the user to avoid any potential accidents which may otherwise result if the hot electrical resistance coil 53 is uncovered while it is in a heated state.

The smart container 30 may be provided with a hollow casing (not shown). More specifically, the hollow casing may be coupled to the outer sidewall 35 of the smart container 30 and may be used to store a plurality of cigarettes therein. Each cigarette may be placed back to back against each other for easy withdrawal from an opening defined proximate to the upper edge 36 of the smart container 30. On withdrawing each cigarette from the casing through the opening, the cigarette may automatically be lit using a lighter that may be coupled proximate to the upper edge 36 of the smart container 30. In an alternate exemplary embodiment, the casing may be coupled to the outer base portion 31 of the smart container 30.

The smart container 30 includes a magnetic compass (not shown) coupled to the outer sidewall 35 of the smart container 30. More specifically the magnetic compass consists of a small, lightweight needle balanced on a nearly frictionless pivot point. One end of the needle is marked “N” for North, or colored to indicate that it points towards North. The magnetic compass facilitates providing a directional guide to the user. In an alternate exemplary embodiment, the magnetic compass may be integrally formed on the outer sidewall 35 of the smart container 30. In an exemplary embodiment, the magnetic compass may be coupled to the control unit 12 through a control flow path.

The smart container 30 includes a heart rate sensor (not shown) that may be coupled to the smart container 30. More specifically, the heart rate sensor may be coupled to the outer sidewall 35 of the smart container 30, and determines the user's heart rate. The user may position the heart rate sensor against his thumb or any other portion of his body for a pre-determined time interval, allowing the heart rate sensor to sense the user's heart rate. The heart rate sensor may be coupled to the control unit 12 through a control flow path. An electronic signal from the heart rate sensor may be transmitted to the control unit 12 that is indicative of the user's heart rate. The control unit 12 may be configured to determine the user's heart rate from the electronic signal that may be received from the heart rate sensor. The control unit 12 facilitates digitally displaying the user's heart rate in the display panel 50 to notify the user.

In an exemplary embodiment, the smart container 30 may be provided with a flash light 17. More specifically, the flash light 17 may be coupled to the outer base portion 31 of the smart container 30 and may be configured to emit a beam of light from a light source (not shown). More specifically, the flash light 17 may be coupled to a switch (not shown) and illuminates an object when the switch is operated by the user. In an alternate exemplary embodiment, the control unit 12 may be coupled to the flash light 17 via a control flow path (not shown). The flash light 17 comprises a light bulb mounted on a reflector and a transparent cover to protect the light source. The reflector may be used to reflect the beam of light that is emitted from the light source.

The smart container 30 may be provided with a laser pointer 13. More specifically, the laser pointer 13 may be coupled to the outer base portion 31 of the smart container 30 and may be configured to emit a visible light from the laser pointer 13. A lens is configured to collimate the visible light emitted from the laser pointer 13. A reflector may be utilized which contains a plurality of independent, controllable reflective surfaces. Each surface may be configured to independently steer a portion of the collimated visible light. In an embodiment, the reflector may be a MEMS micro mirror array, a liquid crystal optical phased array, or a piezo controlled mirror. Applications of the laser pointer 13 may include presentations, demonstrations, classroom training, entertainment, manufacturing, or any other application where it may be necessary to point to, or indicate to an object. The laser pointer 13 may coupled to a switch (not shown) and illuminates an object when the switch may be operated by the user. In an alternate exemplary embodiment, the control unit 12 may be coupled to the laser pointer 13 via a control flow path (not shown).

In an exemplary embodiment, smart container 30 may be provided with a stop watch (not shown). More specifically, the stop watch may be coupled to the smart container 30 for timing an event. The user may activate the stop watch timer when an event begins, and deactivate the stop watch timer after the event is complete. The stop watch may be coupled to the control unit 12 via a control flow path. In an exemplary embodiment, the stop watch may be remotely controlled by the user by transmitting an electronic signal from the electronic device 40 to the electronic receiver 34.

The smart container 30 may be provided with an AM/FM radio receiver (not shown) that may be coupled to the display panel 50. More specifically, the user may monitor a current radio station through the display panel 50, and toggle between various AM/FM radio stations using the touch screen selector provided on the outer sidewall 35 of the smart container 30. In an exemplary embodiment, the AM/FM radio receiver may be integrally or removably coupled to the smart container 30. The AM/FM radio receiver comprises a radio tuner having a radio frequency input and an audio output for providing a radio audio signal. The AM/FM radio receiver may be coupled to a speaker. The radio audio signal may be transmitted from the AM/FM radio receiver to the speaker via a plurality of electronic modulating components for communicating the radio audio signal to the user. The volume level of the speaker may be increased or decreased using the touch screen selector provided on the outer sidewall 35 of the smart container 30. In an alternate exemplary embodiment, an AM/FM radio signal may be transmitted from the electronic device 40 to the electronic receiver 34 that is coupled to the smart container 30. The AM/FM radio receiver may be coupled to the control unit 12 through a control flow path.

The smart container 30 may be provided with a digital music player (not shown) that may be coupled to the display panel 50. More specifically, the user may select a desired song track from a plurality of songs tracks stored in the memory unit 52 using the touch screen selector provided on the outer sidewall 35 of the smart container 30. The digital music player may be coupled to the speaker. A desired song track signal may be transmitted from the digital music player to the speaker in order to play the desired song track for the user. In an alternate exemplary embodiment, the digital music player may be remotely controlled by the user by transmitting an electronic signal from the electronic device 40 to the electronic receiver 34 of the smart container 30. The digital music player may be coupled to the control unit 12 through a control flow path.

The smart container 30 may be provided with a digital camera and/or motion video recorder (not shown). More specifically, the digital camera and/or motion video recorder may be coupled to the outer sidewall 35 of the smart container 30 and allows the user to capture high quality images and/or audio and video recordings. In an alternate exemplary embodiment, the digital camera and/or motion video recorder may be integrally coupled to the outer sidewall 35 of the smart container 30. The digital camera and/or motion video recorder may be activated and deactivated by the user using the touch screen selector provided on the outer sidewall 35 of the smart container 30. The digital camera and/or motion video recorder may be coupled to the memory unit 52. More specifically, the memory unit 52 may be configured to store the captured images and/or audio and video recordings. Electronic transmitter 42 may be configured to transmit the captured images and/or audio and video recordings from the memory unit 52 to the electronic receiver that is coupled to the electronic device 40. In an alternate exemplary embodiment, the captured images and/or audio and video recordings may be transmitted to the electronic receiver that is coupled to the electronic device 40 wirelessly from the digital camera and/or motion video recorder. The captured images and/or audio and video recordings may also be transmitted from the digital camera and/or motion video recorder to any electronic device known in the art such as but not limited to a personal computer, a wireless router, a Bluetooth® device, a smart phone, and a smart container. The digital camera and/or motion video recorder may be coupled to the control unit 12 through a control flow path.

In an exemplary embodiment, smart container 30 may be provided with a pedometer (not shown). More specifically, the pedometer may be coupled to the outer sidewall 35 of the smart container 30. The user may carry the smart container 30 in his person, thereby allowing the pedometer to sense a number of parameters. The pedometer may be coupled to the control unit 12 through a control flow path. An electronic signal from the pedometer may be transmitted to the control unit 12 that is indicative of the parameters that have been sensed by the pedometer. The control unit 12 may be configured to determine the parameters from the electronic signal received from the pedometer. The parameters include but are not limited to a number of steps traversed by the user, a time walked by the user, a distance that has been covered by the user, a distance that remains to be covered after the user has walked a certain distance, and a number of calories burnt by the user. The control unit 12 facilitates digitally displaying the parameters on the display panel 50 to notify the user of the parameters determined by the control unit 12.

The smart container 30 includes a battery compartment 57. More specifically, the battery compartment 57 may be provided within a recess defined within the smart container 30. In an alternate exemplary embodiment, the battery compartment 57 may be coupled to the smart container 30. The battery compartment 57 comprises at least one pair of positive and negative polarity electrical leads (not shown). The positive and negative polarity electrical leads are configured to receive a rechargeable battery therein. The control unit 12 may be coupled to the positive and negative polarity electrical leads through a control flow path to constitute a closed loop electrical circuit. In an exemplary embodiment, power supplied by the rechargeable battery to the positive and negative polarity electrical leads powers the control unit 12. Therefore, all electronic components that have been integrated/coupled to the smart container 30 and coupled to the control unit 12 may be electrically powered by the power supplied to the positive and negative polarity electrical leads by the rechargeable battery.

In an exemplary embodiment, the smart container 30 includes a plurality of battery charging ports 21 that may be coupled to the outer base portion 31 of the smart container 30. More specifically, the battery charging ports 21 may be coupled to each pair of the positive and negative polarity electrical leads through control flow paths. More specifically, the battery charging ports 21 of the smart container 30 may be placed on a battery charging station for charging the rechargeable battery. In an alternate exemplary embodiment, any battery charger known in the art may be electrically coupled to the battery charging ports 21 for charging the rechargeable battery. In yet another alternate exemplary embodiment, power may be supplied directly to the control unit 12 using an external power source through a control flow path.

An inductive battery charger (not shown) may be provided which is platform shaped and which is provided with a charging coil. When the charging coil in the inductive battery charger is energized, the charging coil creates magnetic flux lines. The battery charging ports 21 of the smart container 30 is in a non-direct electrical contact relationship with respect to the inductive battery charger. The battery charging ports 21 includes a pick-up coil which will have an electrical current induced therein when the battery charging ports 21 are positioned adjacent to the inductive battery charger, and the inductive battery charger is energized. The smart container 30 includes circuit means for rectifying the induced current in the pick-up coil to charge the rechargeable battery received within the positive and negative polarity electrical leads. The circuit means includes a rectifier and a current limiting resistor so that the rechargeable battery is self regulating in terms of current and overcharge.

The smart container 30 includes a Universal Serial Bus (USB) port 29. The Universal Serial Bus port 29 may be electronically coupled to the control unit 12 through a control flow path (not shown). The control unit 12 may be electronically coupled to the memory unit 52. In an exemplary embodiment, a battery charging device or an external data transmitting device such as a Universal Serial Bus memory device may be coupled to the Universal Serial Bus port 29. More specifically, in an exemplary embodiment the battery charging device that is coupled to the Universal Serial Bus port 29 may be used to charge the rechargeable battery that is in electrical communication with the positive and negative polarity electrical leads. In an exemplary embodiment, an external power source may be used to supply electrical power to the control unit 12 directly by bypassing the battery compartment 57 of the smart container 30. In an alternate exemplary embodiment, the external data transmitting device that is coupled to the Universal Serial Bus port 29 may be used to transmit audio files, video files, image files, and multimedia files. The audio file formats may include, but are not limited to MP3, AIFF, WAV, MPEG-4, AAC, and Apple Lossless. Example file formats for media content include, but are not limited to files having extensions doc, dot, wpd, txt, xls, pdf, ppt, jpg, jpeg, png, bmp, gif, html, htm, zip, tif, tiff, and wmf. In an exemplary embodiment, the files that are transmitted from the external data transmitting device are stored within the memory unit 52 of the smart container 30.

The smart container 30 includes an insulated storage lid (not shown). More specifically, the insulated storage lid may be coupled to the smart container 30 using a flexible attachment device and is used to cover the opening of the smart container 30 that is exposed to the atmosphere. The insulated storage lid that is used to cover the opening of the smart container 30 thermally insulates the fluid in the cavity of the smart container 30, and prevents excessive heat from dissipating into the atmosphere. In an exemplary embodiment, the insulated storage lid may be provided with an opening to facilitate consuming the fluid content in the smart container 30. The insulated storage lid may be manufactured from any insulating material known in the art that mitigates excessive heat dissipating from the smart container 30 to the atmosphere. In an exemplary embodiment, the insulated storage lid may be coupled to the control unit 12 through a control flow path and may be rotated to cover/uncover the opening defined in the insulated storage lid.

In an exemplary embodiment, the smart container 30 includes a digital display screen (not shown) that may be circumferentially coupled to the outer sidewall 35 of the smart container 30. More specifically, a touch screen selector may be coupled to the digital display screen and may be operated by the user to display motion videos and photographic images on the digital display screen. The digital display screen may be coupled to the control unit 12. The motion videos and photographic images that may be displayed on the digital display screen may be received from the memory unit 52 of the smart container 30. In an alternate exemplary embodiment, the motion videos and photographic images that may be displayed on the digital display screen may be received from an external Universal Serial Bus memory device that may be coupled to the Universal Serial Bus port 29. In an exemplary embodiment, the digital display screen may be an LCD screen, TFT screen, TFT active matrix screen, black and white screen, CSTN screen, and a plasma screen. Alternatively, the digital display screen may be any display screen known in the art that is capable of displaying motion videos and photographic images therein. More typically, the digital display screen includes speakers, head phones or similar devices for producing an audio signal for the content displayed on the digital display screen. The digital display screen has a resolution from about 240×320 to 480×640 and preferably is a 16-18 bit color screen for displaying motion videos and photographic images therein. In an exemplary embodiment, the display panel 50 may be substituted by coupling the digital display screen to the smart container 30. The digital display screen may be coupled circumferentially to the smart container 30 such that a portion of the smart container 30 that includes various electronic sensors, display screen 50, switches, Etc. do not constitute a portion of the digital display screen. In an alternate exemplary embodiment, all user selector options for running any application may be performed using the touch screen selector that is coupled to the digital display screen.

Smart container 30 may be further configured to place/receive a telephone call to/from the recipient through the electronic device 40. More specifically, the user may type a telephone number/select a recipient telephone number from a list of telephone numbers stored in the memory unit 52 using the touch screen selector that is coupled to the digital display screen. The telephone number may be transmitted to the electronic receiver that is coupled to the electronic device 40 via the electronic transmitter 42, and hence place the telephone call to the recipient. Alternatively, the user may accept an incoming telephone call from the recipient through the electronic transmitter that is coupled to the electronic device 40. The user may then communicate with the recipient by speaking into the microphone that may be coupled to the smart container 30. The user may listen to the recipient speaking through a speaker (not shown) that may be coupled to the smart container 30.

In an exemplary embodiment, the smart container 30 includes a fluid level monitoring sensor (not shown) that may be coupled to the control unit 12. More specifically, the fluid level monitoring sensor may be coupled to the inner sidewall of the smart container 30 and monitors the level of fluid in the smart container 30. Therein, the fluid level monitoring sensor transmits an electronic signal to the digital display screen through the control unit 12 that displays the level of fluid in the smart container 30. Thereby, the user may be provided with a digital representation of the level of fluid in the smart container 30.

The digital display screen of the smart container 30 may be configured to receive a plurality of electronic signals from the electronic receiver 34 through the control unit 12. More specifically, the plurality of electronic signals received from the electronic receiver 34 comprises a plurality of pop up advertisements that may be transmitted by a number of vendors. The pop up advertisements may be transmitted by various vendors such as coffee shops, fast food establishments, confectionery stores, airports, railway stations, book stores, Etc. with special offers/promotional coupons/product deals/advertisements to the electronic receiver 34 that is coupled to the smart container 30. The pop up advertisements may be transmitted to the electronic receiver 34 from a remote computer server or from the electronic receiver that may be coupled to the electronic device 40. In an exemplary embodiment, the pop up advertisements that may be displayed on the digital display screen are a function of a time of day, a user's geographical location, a user's preference, Etc. In an exemplary embodiment, when the user is proximate to a coffee shop on an early morning, the coffee shop advertisement/promotional offer may be transmitted by a coffee shop computer server to the electronic device 40/electronic receiver 34. After the user has selected the advertisement/promotional offer using the touch screen selector that may be coupled to the digital display screen, a GPS navigation map may be provided on the digital display screen directing the user from his current geographical location to the coffee shop. In an alternate exemplary embodiment, when the user is within an airport, the business establishments that are located within the airport may transmit advertisements/groupons/discount offers on various products and services offered by the business establishments to the electronic receiver 34 from a remote computer server. In an exemplary embodiment, if the user has a preference for a certain business establishment, advertisements from that specific business establishment may be transmitted frequently to the electronic receiver 34 from the remote computer server. Therefore, the smart container 30 may be adapted to learn the user's product preferences over time and receive special offers/promotional coupons/product deals/advertisements from only those business establishments that appeal to the user. In an alternate exemplary embodiment, the smart container 30 may be manually customizable by the user to receive and display special offers/promotional coupons/product deals/advertisements from select business establishments that appeal to the user. In another embodiment, the pop up advertisements may be stored within the memory unit 52 and displayed on the digital display screen when the smart container 30 is in an offline mode.

In addition to providing special offers/promotional coupons/product deals/advertisements, Etc. the electronic receiver 34 may be configured to receive alerts from a variety of sources. As an example, alerts from an airport terminal server may be transmitted to the electronic receiver 34 and displayed on the digital display screen regarding the user's current flight timing, flight delay alerts, alert messages for flight boarding, Etc. The alerts from the airport terminal server may be transmitted in real time to the electronic receiver 34 thereby allowing the user to track and stay updated on the current status of his flight.

The smart container 30 may be coupled to an internet network through a Wi-Fi network/wireless router. More specifically, the electronic receiver 34 of the smart container 30 may be coupled to the Wi-Fi/wireless router and may be configured to receive data over the internet. In an embodiment, the digital display screen that may be coupled to the smart container 30 may be used to browse through websites, social media, read e-mail, compose e-mail messages, make product selections, and purchase products/services online through a web browser that may be displayed on the digital display screen. The electronic transmitter 42 of the smart container 30 may be coupled to the Wi-Fi/wireless router and may be configured to transmit data over the internet.

The digital display screen of the smart container 30 may be used to display a plurality of screen savers when the smart container 30 is not in use. More specifically, a timer device coupled to the smart container determines if the smart container 30 has not been used for a pre-determined time interval. If the smart container 30 has not been used by the user for the pre-determined time interval, the digital display screen displays a plurality of screen savers. Examples of screen savers include changing color of the digital display screen at periodic time intervals, screen saver pictures, photographs, Etc. Moreover, the digital display screen may be configured to display different colors when different electronic signals are received by the electronic receiver 34. More specifically, the digital display screen may be configured to display a different color for each sender that transmits an electronic text message/makes a telephone call to the electronic device 40, wherein the electronic device 40 is electronically coupled to the smart container 30. The digital display screen may also be configured to display a different color when different notifications, advertisements, Etc. may be received by the electronic receiver 34 of the smart container 30.

The smart container 30 includes a bump sensor (not shown) that may be coupled to the smart container 30. The bump sensor may be coupled to the control unit 12. In an exemplary embodiment, when the bump sensor comes in contact with a bump sensor of another smart container, the contact information of the user may be transmitted from the smart container 30 to the other smart container. More specifically, the contact information of the user may be retrieved from the memory unit 52 and transmitted via the transmitter 42 to an electronic receiver that may be coupled to the other smart container and vice versa. In an exemplary embodiment, any electronic information contained in the memory unit 52 of the smart container 30 may be programmed by the user to be transmitted via the transmitter 42 to the electronic receiver that may be coupled to the other smart container.

The smart container 30 includes a toxicity sensor (not shown) that may be coupled to the inner sidewall. The toxicity sensor may coupled to the control unit 12. In an embodiment, if a toxic drug is added to the smart container 30, the toxicity sensor detects the presence of the toxin and transmits an electronic signal to the control unit 12. The control unit 12 may then activate the audible alarm 99 or an LED coupled proximate to the LED 11 to warn the user of the toxin in the smart container 30.

In an exemplary embodiment, a strap (not shown) may be coupled to the smart container 30. The strap that may be coupled to the smart container 30 may be coupled to a wrist of the user using any fastening means known in the art such as but not limited to a buckle. The smart container 30 may be programmed to store maps of a venue such as but not limited to an amusement park within the memory device 52. A computer server of the venue may transmit electronic signals to the electronic receiver 34 of the smart container 30 containing venue information, agenda for a day, venue map, the user's current geographical location within the venue, venue events, when the user's spot in a line comes up, venue closing time, provide directions to a hot spot, hot spots in proximity to the current geographical location of the user, advertisements, emergency information, Etc. Linked smart containers/linked electronic devices belonging to other users may be displayed on the map of the digital display screen of the smart container 30 to facilitate the user from locating other users who may belong to the same group. The link between the smart containers/linked electronic devices and the smart container 30 may be but not limited to a venue's network.

In an exemplary embodiment, a handle 48 may be coupled to the smart container 30. More specifically, the handle 48 may be coupled to the outer sidewall 35 of the smart container 30 for grasping by the user. In addition, the rechargeable battery may be shaped in a form of the handle 48 and coupled to the outer sidewall 35 of the smart container 30. The handle 48 may be secured to the outer sidewall 35 of the smart container 30 by welding electrical terminals of the handle 48 to electrical leads provided on the outer sidewall 35 of the smart container 30. In an alternate exemplary embodiment, the electrical terminals of the handle 48 may be secured to the outer sidewall 35 of the smart container 30 using any mechanical fastening means known in the art such as but not limited to a screw. The electrical leads provided on the outer sidewall 35 of the smart container may be electrically coupled to the control unit 12. The handle 48 that may be coupled to the smart container 30 may have a left hand/right hand grasping feature therein. More specifically, when the user grasps the handle 48 with his right hand, the digital display screen may be configured to display on a first portion of the digital display screen facing the user. When the user grasps the handle 48 with his left hand, the digital display screen may be configured to display on a second portion of the digital display screen facing the user.

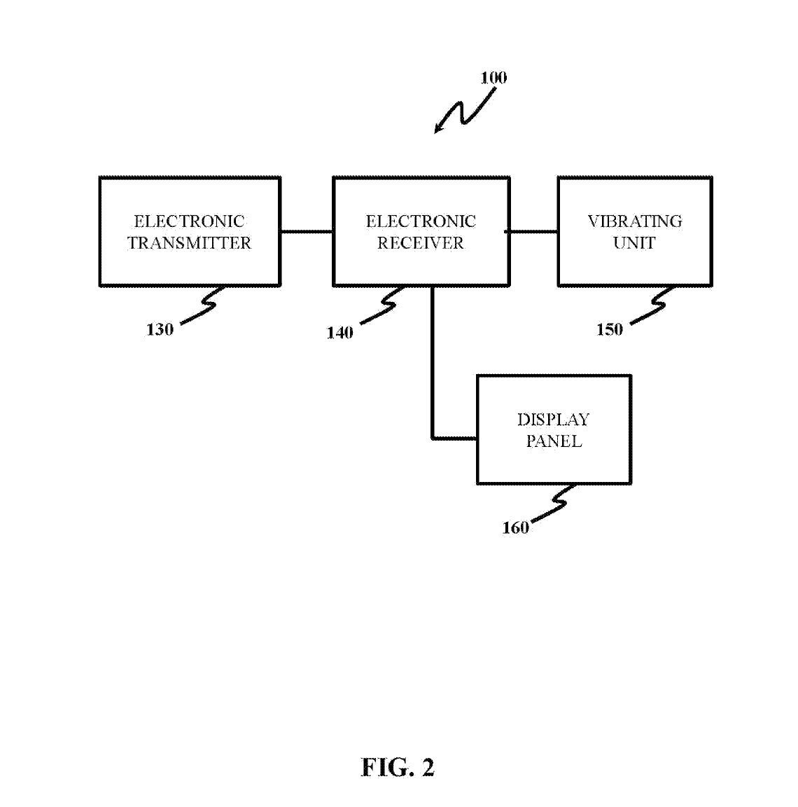

FIG. 2 is a block diagram 100 of a communication system between the electronic device 40 and smart container 30. In the exemplary embodiment, electronic transmitter 130 is coupled to the electronic receiver 140 and is configured to transmit an electronic signal when communication is received by the electronic device 40. Electronic transmitter 130 is in electronic communication with the electronic receiver 140 that is coupled to the smart container 30. More specifically, electronic receiver 140 is configured to receive the electronic signal from the electronic transmitter 130 when communication in the form of a telephone call or electronic text message is received by the electronic device 40. Electronic receiver 140 is coupled to the vibrating unit 150. More specifically, electronic receiver 140 is configured to facilitate actuating the vibrating unit 150 when the electronic signal is received in the electronic receiver 140 to alert the user of the received electronic signal. Electronic receiver 140 is further configured to be coupled to the display panel 160. More specifically, electronic receiver 140 is configured to facilitate displaying the electronic signal on the display panel 160 to notify the user of the telephone number of the caller or the electronic text message from the sender that has been received by the electronic device 40.

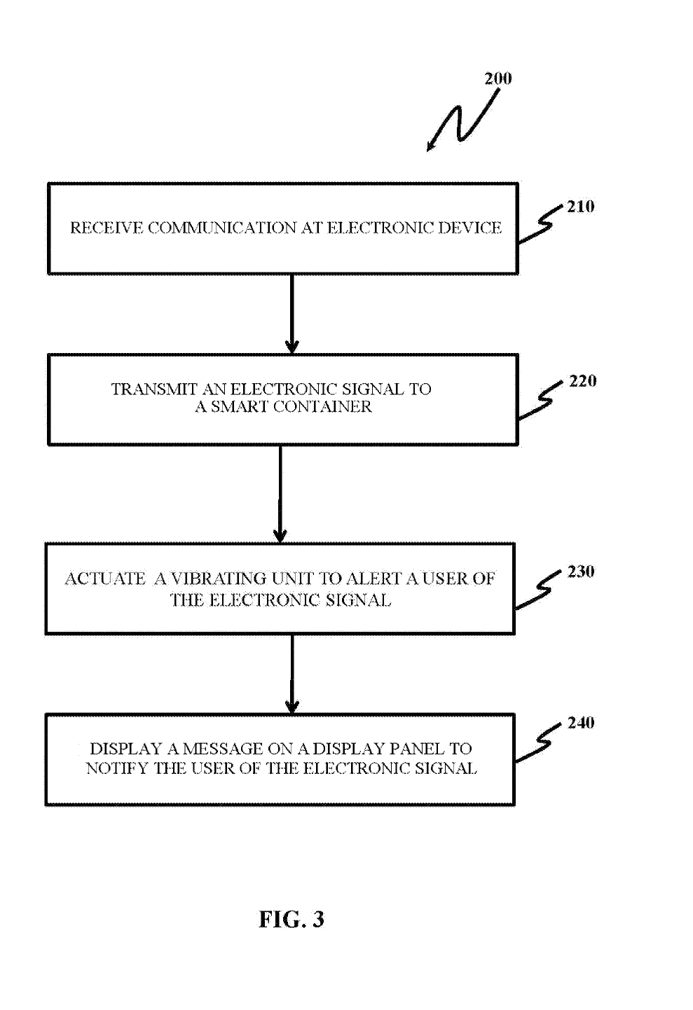

FIG. 3 is a flow diagram showing an exemplary control method 200 of operating the smart container and electronic device 10 in accordance with an embodiment of the present invention. In the exemplary embodiment, method 200 includes receiving 210 communication at the electronic device 40. More specifically, electronic device 40 includes an electronic receiver coupled within the electronic device 40 and is configured to receive the telephone call from the caller or the electronic text message from the sender.

Method 200 includes transmitting 220 an electronic signal to the smart container 30. In the exemplary embodiment, the electronic transmitter coupled to the electronic device 40 is electronically coupled to the electronic receiver 34 and is configured to transmit the electronic signal to the electronic receiver 34. More specifically, the electronic transmitter coupled to the electronic device 40 is configured to transmit the electronic signal comprising the electronic text message with identifying information including the telephone number and/or an associated name of the sender, or identifying information including the telephone number and/or an associated name of the caller to the electronic receiver 34.

In an exemplary embodiment, method 200 includes actuating 230 the vibrating unit 38 to alert the user of the received electronic signal. More specifically, the electronic receiver 34 is coupled to the vibrating unit 38 and is configured to facilitate actuating the vibrating unit 38 when the electronic signal is received by the electronic receiver 34. The vibrations generated by the vibrating unit 38 are conductively transmitted to the outer sidewall 35 of the smart container 30 that is in physical contact with a skin of the user. Consequently, the user is cognizant of the electronic signal received by the electronic receiver 34.

Method 200 includes displaying 240 an electronic message on the display panel 50 of the smart container 30 to notify the user of the received electronic signal. More specifically, display panel 50 is coupled to the electronic receiver 34 and is configured to display the electronic signal comprising the electronic text message with identifying information including the telephone number and/or the associated name of the sender, or identifying information including the telephone number and/or the associated name of the caller.

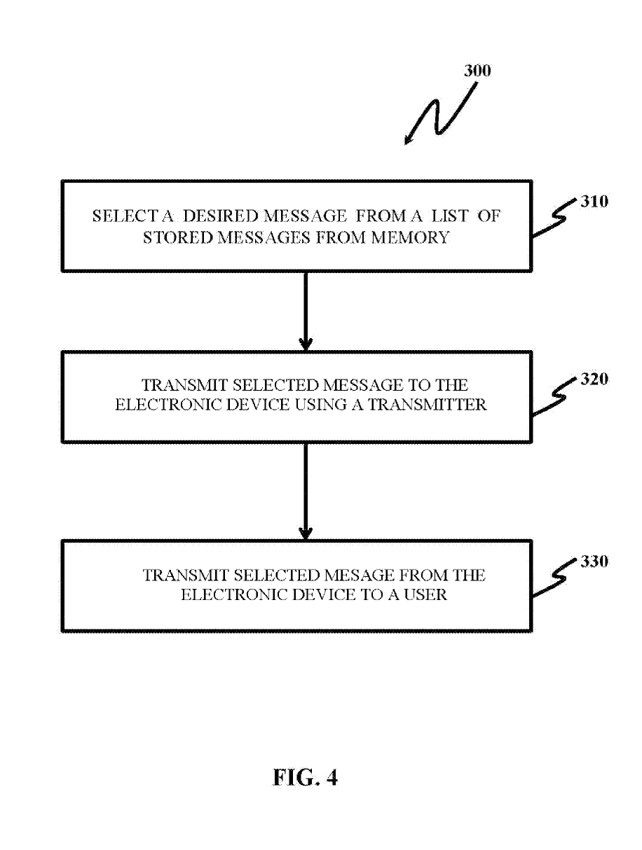

FIG. 4 is a flow diagram showing an exemplary control method 300 of operating the smart container and electronic device 10 in accordance with an embodiment of the present invention. In the exemplary embodiment, method 300 includes selecting 310 an electronic text message from a list of stored electronic text messages from the memory unit 52 of the smart container 30 by operating the selector option switch 56. The selected electronic text message may be subsequently confirmed by operating the confirming option switch. In addition, method 300 includes selecting the telephone number of the recipient/associated recipient name from the finite list of telephone numbers/associated recipient names acquired by the memory unit 52 by operating the selector option switch 56 and subsequently confirmed by operating the confirming option switch.

Method 300 includes transmitting 320 the selected electronic text message and telephone number/associated recipient name to the electronic receiver coupled to the electronic device 40. More specifically, the electronic transmitter 42 coupled to the memory unit 52 is configured to transmit the selected electronic text message and telephone number/associated recipient name to the electronic receiver coupled to the electronic device 40. In an alternate exemplary embodiment, the recipient telephone number/associated recipient name that is transmitted from the electronic transmitter 42 to the electronic receiver that is coupled to the electronic device 40 may be substituted with any other identifier known in the art that would enable the electronic device 40 to be cognizant of the destination to which the electronic text message is required to be transmitted.

In the exemplary embodiment, method 300 includes transmitting 330 the selected electronic text message from the electronic device 40 to the telephone of the recipient. More specifically, the electronic transmitter coupled to the electronic device 40 is configured to automatically transmit the selected electronic text message received from the electronic transmitter 42 to the telephone of the recipient.

The smart container and electronic device 10 facilitates remotely receiving an electronic signal by a smart container 30 from an electronic device 40. Moreover, the vibration induced by the smart container 30 enables the user to be cognizant of communication received by the electronic device 40 while remaining discreet at the same time in certain situations such as in private meetings, social gatherings, Etc.

The smart container and electronic device 10 may be used to conserve battery power in the electronic device 40. As a consequence of the user being alerted by the smart container 30 of the communication received in the electronic device 40, the audible alarm in the electronic device 40 may be deactivated, thereby enabling the user to conserve on battery power. In addition, transmitting a continuous electronic signal comprising the date and time to the smart container 30 enables the user to travel between various national/international time zones, and still be equipped to receive the current date and time at a specific geographical location. Moreover, transmitting a variety of continuous/intermittent electronic signals at user desired ranges that include a calendar appointment notification signal, an e-mail notification signal, a current weather signal, a current altitude signal, a current temperature signal, a current pressure signal, a current stock ticker signal, a current sport score signal, a current news flash signal, a ring tone signal, a video conferencing signal, a current GPS navigation signal, an advertisement signal, a photographic image signal, a motion video signal, an audio signal, a social media notification signal, Etc. from the electronic device 40 to the electronic receiver 34 of the smart container 30 eliminates the requirement of integrated transducer devices for measuring, determining, and notifying a few of the parameters mentioned above to the user. Therefore a cost incurred to the user may be substantially reduced, while simultaneously enhancing the utility value of the smart container 30. Moreover, applications created in the electronic device 40 for the smart container 30 may be transmitted to the electronic receiver 34 of the smart container 30 such that the applications may be accessed by the user using the digital display screen that may be coupled to the smart container 30.

The above described smart container and electronic device 10 is cost effective and highly reliable. In addition, the modular nature of each sub-system of the smart container and electronic device 10 facilitates easy disassembly and replacement of individual system components as required.

Exemplary embodiments of a smart container and electronic device are described above in detail. The system is not limited to the specific embodiments described herein, but rather, components of each system may be utilized separately and independently from other components described herein.

While the invention has been described in terms of various specific embodiments, those skilled in the art will recognize that the invention can be practiced with modifications within the spirit and scope of the claims.

What is claimed is:

1. A method for receiving a first electronic signal in a smart container and notifying a user of the first electronic signal, said method comprising:
coupling an electronic receiver to the smart container;
coupling a display panel to the electronic receiver;
receiving the first electronic signal by the electronic receiver from an electronic device transmitter; and
digitally displaying the first electronic signal on the display panel to notify the user of the first electronic signal.

2. A method in accordance with claim 1 wherein receiving the first electronic signal includes receiving the first electronic signal comprising one of an electronic text message with identifying information of a sender and identifying information of a caller.

3. A method in accordance with claim 1 further comprising:
coupling a memory unit to the electronic receiver; and
storing the first electronic signal received by the electronic receiver in the memory unit.

4. A method in accordance with claim 3 further comprising:
coupling an electronic transmitter to the memory unit; and
transmitting a second electronic signal from the electronic transmitter to an electronic device receiver.

5. A method in accordance with claim 1 further comprising coupling a control unit to the smart container, the control unit configured to control the electronic receiver.

6. A method in accordance with claim 1 further comprising providing a battery compartment within the smart container, the battery compartment containing at least one pair of positive and negative polarity electrical leads.

7. A method in accordance with claim 1 further comprising coupling one of an electrical resistance coil and a flame burner to one of an outer base portion, an outer sidewall, and a handle of the smart container.

8. A method in accordance with claim 1 further comprising coupling a digital display screen circumferentially to the smart container and coupling a touch screen selector to the digital display screen, the digital display screen configured to display at least one of a motion video, a photographic image, and a web browser.

9. A smart container, said smart container comprising:
a base portion;
a sidewall integrally formed with and extending upwardly from said base portion, said sidewall surrounding an inner cavity and having an upper edge defining an opening into the inner cavity;
an electronic receiver coupled to one of said base portion and said sidewall, said electronic receiver configured to receive a first electronic signal; and
a display panel coupled to said electronic receiver, said display panel configured to digitally display the first electronic signal.

10. A smart container in accordance with claim 9 wherein the first electronic signal comprises one of an electronic text message with identifying information of a sender and identifying information of a caller, and wherein the first electronic signal is received from an electronic device transmitter.

11. A smart container in accordance with claim 9 further comprising a memory unit coupled to said electronic receiver, said memory unit configured to store the first electronic signal.

12. A smart container in accordance with claim 11 further comprising an electronic transmitter coupled to said memory unit, said electronic transmitter configured to transmit a second electronic signal to an electronic device receiver.

13. A smart container in accordance with claim 9 further comprising a control unit coupled to said smart container, said control unit configured to control said electronic receiver.

14. A smart container in accordance with claim 9 further comprising a battery compartment provided within a recess defined in said smart container, said battery compartment containing at least one pair of positive and negative polarity electrical leads.

15. A smart container in accordance with claim 9 further comprising a digital display screen coupled circumferentially to said sidewall of said smart container and a touch screen selector coupled to said digital display screen, said digital display screen configured to display at least one of a motion video, a photographic image, and a web browser.

16. A method for coupling at least one electronic component to a smart container, said method comprising:
coupling one of an electrically powered heating element and an infrared heater to one of an inner base portion and an inner sidewall of the smart container for heating fluid content in the smart container.

17. A method in accordance with claim 16 further comprising coupling a proximity sensor to an outer base portion of the smart container for determining if the smart container has been placed on a substantially flat surface.

18. A method in accordance with claim 16 further comprising at least one of:
coupling an audible alarm to the smart container for emitting an alarm when a first electronic signal is received by the smart container; and
coupling a vibrating unit to the smart container for vibrating when the first electronic signal is received by the smart container.

19. A method in accordance with claim 16 further comprising at least one of:
coupling a microphone to the smart container for communicating an audio signal to the smart container; and
coupling a stirrer to the smart container for stirring fluid content in the smart container.

20. A method in accordance with claim 16 further comprising at least one of:
coupling a thermometer to the smart container for measuring a user's body temperature; and
coupling an alcohol sensor to the smart container for measuring a concentration of alcohol consumed by a user.
